(19) United States
(12) Patent Application Publication
(10) Pub. No.: US 2015/0072750 A1
(43) Pub. Date: Mar. 12, 2015

(54) ELECTRONIC CASINO-STYLE BINGO GAME SYSTEM

(71) Applicant: Centurion Games Inc., Tulsa, OK (US)

(72) Inventor: Marcelo Rinaldis, Tulsa, OK (US)

(73) Assignee: Centurion Games Inc.

(21) Appl. No.: 14/478,243

(22) Filed: Sep. 5, 2014

Related U.S. Application Data
(60) Provisional application No. 61/875,777, filed on Sep. 10, 2013.

(51) Int. Cl. G07F 17/32

(52) U.S. Cl. CPC G07F 17/329; G07F 17/3258
USPC 463/19

(57) ABSTRACT

An improved electronic casino-style BINGO game system is described. In one or more embodiments of the invention, a casino-style BINGO game system provides incentive for extended play by allowing a player to purchase special BINGO cards, the special BINGO cards increasing the player's ability to win a jackpot. When a special BINGO card is purchased by a player, the player receives a new special BINGO card mid-game. The new, special BINGO card comprises preexisting hits, and requires significantly fewer additional hits to reach a coverall pattern than would be expected with a conventional BINGO card at a similar point in the BINGO game.

### CROSS REFERENCE TO RELATED APPLICATIONS

This application claims the benefit of U.S. Provisional Application No. 61/875,777 to Rinaldis, filed Sep. 10, 2013 and entitled “ELECTRONIC CASINO-STYLE BINGO GAME SYSTEM,” which is hereby incorporated by reference in its entirety.

### BACKGROUND OF THE INVENTION

1. Field of the Invention

Embodiments of the invention described herein pertain to the field of games of chance. More particularly, but not by way of limitation, one or more embodiments of the invention enable an improved electronic casino-style BINGO game system.

2. Description of the Related Art

BINGO is a fun game of chance enjoyed by many. In a traditional BINGO game, a player must match symbols on a game card to the symbols drawn from a pot. When a symbol on the player's card matches one drawn from the pot the player marks (“daubs”) the matching symbol. When a player's daubs match a winning pattern of symbols, the player calls “BINGO!” If the daubs are confirmed the player wins the game.

Public gaming casinos and other public gaming establishments have many different types of machines available for individual gambling. Such machines are sometime referred to as “slot machines,” which will be referred to here as casino-style gaming machines. Casino-style gaming machines are not limited to mechanical machines, but also encompass electronic computer-controlled devices that may be stand-alone or be networked with other machines in a casino. Some casino-style gaming machines may have mechanical wheels that turn when the player “spins,” while others may have a computer display that represents the traditional spinning wheels.

In recent years, various forms of electronic casino BINGO games have become popular. Gambling casinos have incorporated the traditional game of BINGO in many different forms into casino-style gaming machines.

As with any business, casinos wish to maximize profits. In public casinos, profits may be increased by encouraging players of casino-style gaming machines to play more games during their time at the machines. Players enjoy having more options to control the game and so may play longer when provided such options. It would be a desirable improvement to have novel ways to extend the excitement and play time for a player using a casino-style gaming machine to play BINGO.

FIG. 1 illustrates a typical casino-style gaming system of the prior art comprising a classic electronic bingo machine, a payment system, a mechanical or digital display showing symbols or icons and various indicators of the game elements and status of the current game. In a digital BINGO system, the symbols may be randomly generated for each displayed position (cell) in the display matrix (table of rows and columns) of the BINGO cards. A gaming system with digital display may include a local computer processor and local data storage and/or a network connection to a central controller, for example.

Casino-style gaming systems of the prior art may be similar to the one illustrated in FIG. 1. The classic casino-style BINGO game system may generally comprise an apparatus such as casino-style gaming machine 100. Casino-style gaming machine 100 may comprise appropriate conventional display screen 110 displaying traditional BINGO card 115, various betting buttons 120, payment processing mechanical and computer systems 140, drawn electronic bingo ball 125 and attention light 160. Computer systems to create and display the game, equipment to communicate with a central control center, sound generation devices, and software to provide the BINGO game may reside inside case 170.

To continue to bring more players to casinos it is well known in the art that new and exciting game variations and improvements are necessary. Therefore, for at least the limitations described above there is a need for an improved electronic casino-style BINGO game system.

### BRIEF SUMMARY OF THE INVENTION

One or more illustrative embodiments enable an improved electronic casino-style BINGO game system, the system comprising a casino-style BINGO apparatus, software and hardware that provides new options to allow a player having a first electronic bingo card purchased at the start of a BINGO game to purchase a special new bingo card mid-game, the special bingo card comprising preexisting hits and requiring fewer additional hits to be a winner than the first electronic bingo card would be expected to have at that mid-game point, in order to increase the player's chance of obtaining a coverall pattern.

An illustrative embodiment of a computer program product comprising a non-transitory machine-readable storage medium having computer program code stored thereon which when executed by a computer causes the computer to perform the computer program code, the computer program code conducting an improved electronic bingo game variation comprises generating a first electronic bingo card for an electronic bingo game, wherein the first electronic bingo card comprises a matrix of squares, each square comprising an assigned character chosen from a predetermined set of available characters, drawing a series of bingo balls, each bingo ball comprising a character selected from the predetermined set of available characters, thereby creating a drawing pool, wherein a hit occurs when the character on a first drawn bingo ball matches one of the assigned characters on the first electronic bingo card, pausing the electronic bingo game when a predetermined number of the bingo balls in the drawing pool have been drawn, wherein the predetermined number of bingo balls is less than a number of bingo balls in the series of bingo balls, offering a new electronic bingo card for purchase while the electronic bingo game is paused, the new electronic bingo card comprising a disclosed number of hits at a time of purchase, wherein the disclosed number of hits is greater than an expected number of hits on the first electronic bingo card at the time of purchase of the new electronic bingo card, continuing the electronic bingo game with the new electronic bingo card and bingo balls drawn from a remaining portion of the drawing pool, wherein the new electronic bingo card comprises an undaubed character selected from the remaining portion of the drawing pool, and awarding a jackpot prize when a particular electronic bingo card from a set of all first electronic bingo cards and new electronic bingo cards in the electronic bingo game obtains a coverall pattern. In some embodiments, at the time of purchase the new electronic bingo card requires fifty percent fewer additional hits than the first electronic bingo card would be expected to require to reach the coverall pattern. In certain embodiments, there are ninety available characters in the predetermined set and the electronic bingo game is paused when the predetermined number of the bingo balls is one of forty-one, fifty-four, or sixty-eight or a combination thereof. In some embodiments, the new electronic bingo card requires between one and four additional hits to reach a coverall pattern. In certain embodiments, the matrix of squares comprises fifteen squares and the drawing pool comprises ninety balls.

An illustrative embodiment of an improved method of providing an electronic bingo-type game on a casino-style gaming machine, the method performed by a computer, wherein the computer further comprises a non-transitory storage device, the method comprises generating a first electronic bingo card for an electronic bingo game, wherein the first electronic bingo card comprises a matrix of squares, each square comprising an assigned character chosen from a predetermined set of available characters, drawing a series of bingo balls, each bingo ball comprising a character selected from the predetermined set of available characters, thereby creating a drawing pool, wherein a hit occurs when the character on a first drawn bingo ball matches one of the assigned characters on the first electronic bingo card, pausing the electronic bingo game when a predetermined number of the bingo balls in the drawing pool have been drawn, wherein the predetermined number of the bingo balls is less than a number of bingo balls in the series of bingo balls, offering a new electronic bingo card for purchase while the electronic bingo game is paused, wherein the new electronic bingo card offered is three hits away from a coverall pattern, continuing the electronic bingo game with the new electronic bingo card and bingo balls drawn from a remaining portion of the drawing pool, wherein the new electronic bingo card comprises an undaubed character selected from the remaining portion of the drawing pool, and awarding a jackpot prize when a particular electronic bingo card from a set of all cards in play in the electronic bingo game obtains the coverall pattern. In some embodiments, the new electronic bingo card is offered a first time when forty-one balls in the drawing pool have been drawn and a second time when fifty-four balls in the drawing pool have been drawn. In some embodiments, the new electronic bingo card replaces the first electronic bingo card. In other embodiments, the set of all cards in play in the electronic bingo game comprises the first electronic bingo card and the new electronic bingo card.

An illustrative embodiment of an electronic apparatus comprising a non-transitory machine-readable storage medium having computer program code stored thereon which when executed by a machine causes the machine to perform a method of conducting an electronic bingo game variation, the method comprises generating a first electronic bingo card for an electronic bingo game, wherein the first electronic bingo card comprises a matrix of squares, each square comprising an assigned character chosen from a predetermined set of available characters, drawing a series of bingo balls, each bingo ball comprising a character selected from the predetermined set of available characters, thereby creating a drawing pool, wherein a hit occurs when the character on a first drawn bingo ball matches one of the assigned characters on the first electronic bingo card, pausing the electronic bingo game when a predetermined number of the bingo balls in the drawing pool have been drawn, offering a new electronic bingo card for purchase while the electronic bingo game is paused, the new electronic bingo card comprising hits from the drawing pool when offered, and wherein the new electronic bingo card requires fewer additional hits towards a winning pattern than the first electronic bingo card in expected value at a time the game is paused, continuing the electronic bingo game with the new electronic bingo card and bingo balls drawn from a remaining portion of the drawing pool, wherein the new electronic bingo card comprises an undaubed character selected from the remaining portion of the drawing pool, and awarding a jackpot prize when a particular electronic bingo card from a set of all first electronic bingo cards and new electronic bingo cards in the electronic bingo game obtains the winning pattern. In some embodiments, a cost of the first electronic bingo card is equal to a cost of the new electronic bingo card, and wherein a number of the new electronic bingo cards offered is equal to a number of the first electronic bingo cards generated. In certain embodiments, the winning pattern is a coverall pattern. In other embodiments, the winning pattern is two lines. In some embodiments the machine further performs a method comprising guaranteeing that the new electronic bingo card requires fewer additional hits towards the winning pattern than the first electronic bingo card. In certain embodiments the machine further performs a method comprising confirming an accuracy of hits daubed.

In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

The above and other aspects, features and advantages of illustrative embodiments will be more apparent from the following more particular description thereof, presented in conjunction with the following drawings wherein:

FIG. 1 illustrates a prior art casino-style gaming system.

FIG. 2 is a schematic diagram of a casino-style BINGO game display device showing a special card option of an illustrative embodiment.

FIG. 3 illustrates a flow chart of a method of play of a casino-style BINGO game including the special card option of an illustrative embodiment.

FIG. 4 is diagram of a special bingo card of an illustrative embodiment.

While the invention is susceptible to various modifications and alternative forms, specific embodiments thereof are shown by way of example in the drawings and may herein be described in detail. The drawings may not be to scale. It should be understood, however, that the specific illustrative embodiments that are depicted and described in the drawings and detailed description are not intended to limit the invention to the particular form disclosed, but on the contrary, the intention is to cover all modifications, equivalents and alternatives falling within the spirit and scope of the present invention as defined by the appended claims.

### DETAILED DESCRIPTION

An improved electronic casino-style BINGO game system will now be described. In the following exemplary description numerous specific details are set forth in order to provide a more thorough understanding of illustrative embodiments. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention.

As used in this specification and the appended claims, the singular forms “a”, “an” and “the” include plural referents unless the context clearly dictates otherwise. Thus, for example, reference to a bingo card includes one or more bingo cards.

As used in this specification and the appended claims, the terms “expected”, “expectation” and “expected value” refer to a predicted value of a variable, calculated as the sum of all possible values each multiplied by the probability of its occurrence. Thus, for example, in reference to the number of hits on a bingo card in a bingo game, the expected number of hits on a bingo card after a certain number of balls have been drawn would be the number of hits one would expect to find if one could repeat the ball-drawing process an infinite number times and take the weighted arithmetic mean of the number of hits obtained.

As used herein, the term “public casino” refers to a gaming establishment opened to the public for providing entertainment by way of gambling. Most such public casinos in the United States are legal for-profit businesses that operate under state, federal and/or tribal laws and regulations. Other types of public casinos include temporary or permanent establishments set up for charitable purposes as permitted by law, and as such are also contemplated within the definition of a public casino.

As used herein the terms “slot machine,” “device,” “machine” and “casino-style BINGO game system,” “BINGO slot machine,” and “gaming device” all apply equally and interchangeably to the modern electronic casino-style gaming devices, still commonly called “slot machines.” As described above and herein, the term “slots” or “slot machines” is intended to encompass games providing or simulating three or more electronic “spinning reels” as in slots, as well as those offering electronic poker, BINGO, roulette and other games of chance, such as those well known to players of casino games.

As used herein, the term “button” means a selectable, clickable and/or tappable rendered image, region, icon, touch screen button, mechanical button, switch or any combination thereof. As used herein the term “button click” means a user selection of a button. In a preferred embodiment, the gaming machine display user interface is a color, touch screen display device. As used herein the term “selection” or “click” is used interchangeably to refer to the action of a user making a selection or pressing, tapping, or touching a button.

Only non-transitory computer-readable media (storage devices) are within the scope of this application and the appended claims. As used in this specification and the appended claims, non-transitory storage devices comprise all computer-readable media except for a transitory, propagating signal.

Casino-Style Gaming System

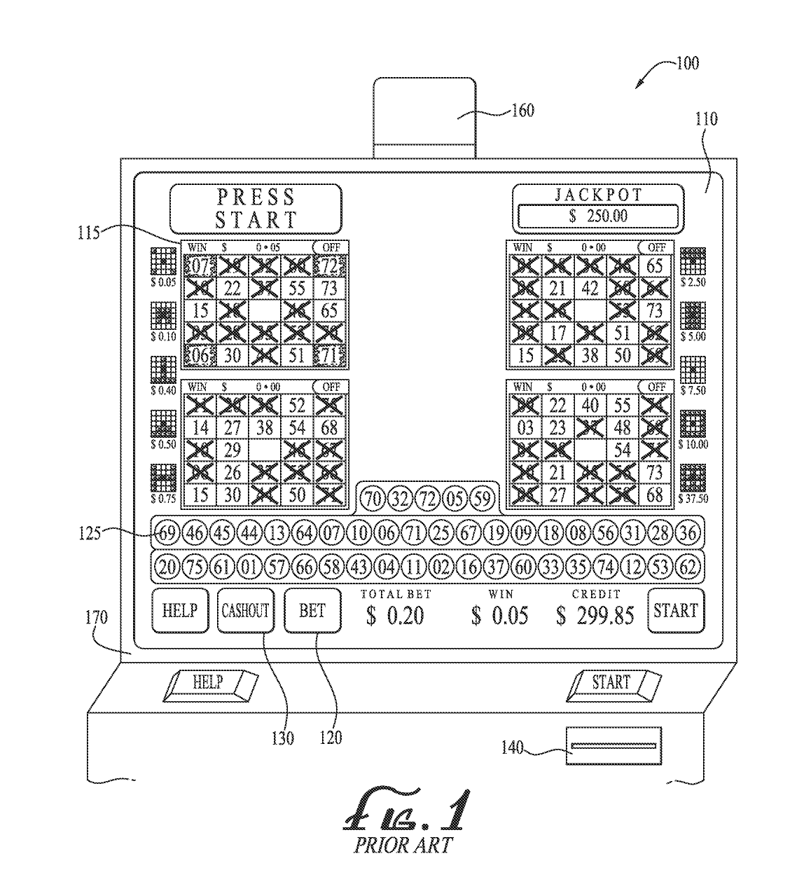

An exemplary casino-style gaming system capable of providing the game of illustrative embodiments may be, for example, a classic digital display slot machine such as, for example, the system of FIG. 1. Casino-style gaming machines are generally subject to local, state and/or federal gambling regulations that may control the size, placement, construction, location, payout rates and other system configuration considerations. Such restrictions are contemplated by illustrative embodiments and are considered further limitations to the casino-style gaming system invention as described.

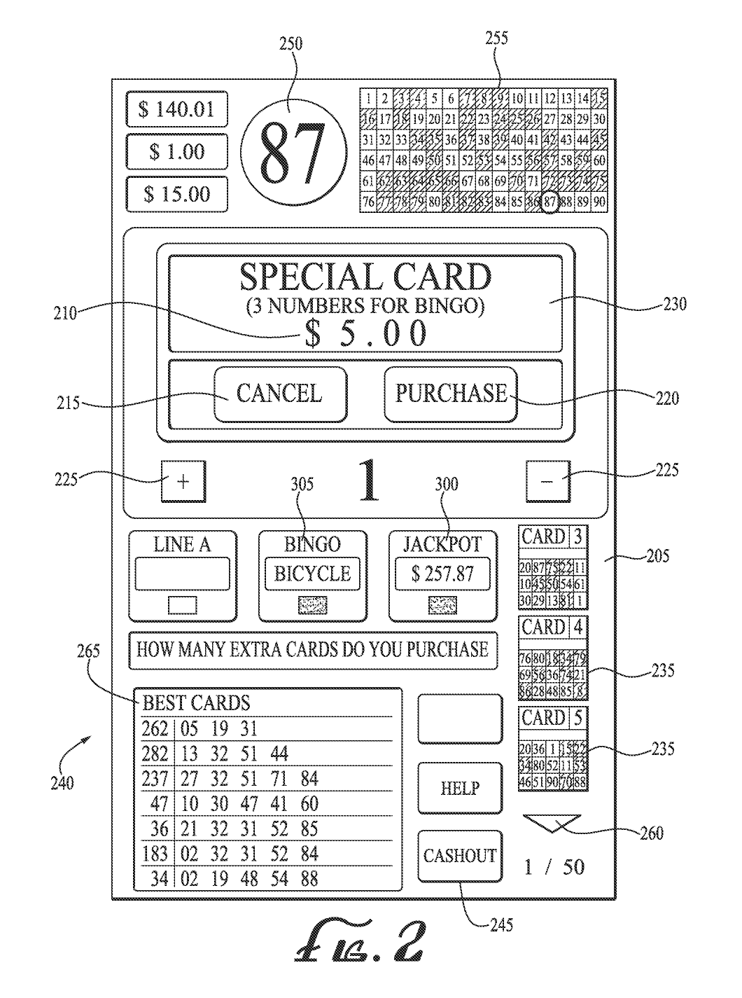

In other embodiments, a casino-style gaming system capable of providing the game of illustrative embodiments may be as illustrated in FIG. 2. As shown in FIG. 2, display device 240 includes special card selection region 230 having one or more mechanical or touch screen buttons. Special card selection region 230 may pop up on a player's screen, light up or otherwise indicate to the player when the special card option is available or not during a particular game of illustrative embodiments. In the embodiment shown in FIG. 2, a tappable special card selection region 230 may appear or “pop up” on screen 205, inquiring as to whether the player would like to purchase a special card. The inquiry may inform the player as to the price of the special card at price tag 210. The player may then select cancel button 215 to decline the special card or purchase button 220 to buy the special card. As shown in FIG. 2, a player may purchase one, or in some embodiments more than one, special card at a particular juncture in the game, by pressing quantity buttons 225. Price tag 210, cancel button 215, purchase button 220 and/or quantity buttons 225 may all be located in special card region 230.

The Display

The display device 240 of a casino-style gaming machine of the system of illustrative embodiments may comprise a digital display of any serviceable type, many of which are well-known to those of ordinary skill in the art of the computer, television and gaming industries. A display screen 205 supporting illustrative embodiments may comprise electronic bingo cards 235, each bingo card 235 including a table (matrix) of rows and columns showing the various symbols (characters) of the game. As is well known in the art, casino-style gaming systems generally comprise a theme or motif that adds interest and excitement to the game. The various motifs, such as fanciful, wistful, scary, wilderness, romantic, movie or TV show theme or others, for example, may distinguish the machines in the minds of the players. However, the character motif is not a distinguishing feature of illustrative embodiments. While illustrative embodiments here illustrate and describe numbers as the characters on the bingo balls and bingo cards, any type of symbol motif may be used to implement the game of illustrative embodiments.

FIG. 2 also illustrates a display for one or more popular BINGO-like casino-style games. In some embodiments, display device 240 may be a touch screen tablet, which may be played simultaneously and/or interspersedly with another slot machine on a casino floor. Display device 240 may comprise one, two, three, four or more bingo cards 235 displayed at the same time. Many players may enjoy playing multiple games at one time in order to increase the excitement of the games. For example, a player may play an electronic poker game on a traditional slot machine as shown in FIG. 1 whilst simultaneously playing a BINGO game of illustrative embodiments on display device 240. In another example, a player may play ten, twenty, thirty or two-hundred-and-fifty bingo cards 235 in a single BINGO game on display device 240 of an illustrative embodiment.

In some embodiments, a player may play multiple bingo cards 235 in a single BINGO round or game. As shown in FIG. 2, display device 240 includes scroll arrow 260, which may allow a player to scroll through many bingo cards 235 being played by the player in a single bingo game. Board 265 may display the status of the player's best cards during play of the game of illustrative embodiments, for example to assist a player in keeping track of the status of bingo cards 235 throughout play of the game. As shown in FIG. 2, the player's best bingo card 235 is card number “262”, for which this player still needs three additional hits to reach a coverall pattern; characters 5, 19 and 31 must still be drawn from the bingo ball drawing pool in order to achieve a coverall pattern on that particular card number “262”.

Selection indicators, such as cashout button 245 may be mechanical buttons or digital indicators that are selectable through various means well known to those in the art of casino-style machine design. Drawn bingo ball 250 may be displayed on display device 240, along with ball chart 255, which ball chart 255 may display all possible characters which may be called, and highlight the characters which have actually been called up to that point in the current game. In the example shown in FIG. 2, the characters one through ninety may potentially be drawn and called. As such, the numbers one through ninety are displayed on ball chart 255, with the numbers that have already been called during the game highlighted or shaded. Also as shown in FIG. 2, the most recent ball to have been drawn from the drawing pool is drawn bingo ball 250, which in this example is ball number “87”. As illustrated, the number “87” is also circled on ball chart 255 as the most recently drawn ball.

As is well known in the art, a casino-style gaming system such as those that support illustrative embodiments may include bingo cards 235 containing a number of rows and/or columns. Illustrative embodiments contemplate any number of rows and/or columns of display symbols (characters) that will allow play of the game of illustrative embodiments. As an example, the following illustrations show bingo cards 235 with three (3) rows and five (5) columns, but one of ordinary skill in the art will understand that illustrative embodiments may be embodied with a different number of rows and/or columns, for example five rows and five columns. For clarity this description will focus on touch-screen buttons, but illustrative embodiments are not so limited.

When a drawn bingo ball 250 is selected by a computer and/or display device 240 from the drawing pool of bingo balls, if the drawn bingo ball 250 matches a character on one or more of the player's bingo cards 235, the player may daub the match (hit) by touching and/or selecting that number on the appropriate bingo cards 235. In embodiments where a player plays multiple cards 235 at one time, touching the “called” character on ball chart 255 or on a single card 235 may be sufficient to daub that character on all bingo cards 235 held by the player where that symbol appears. In other embodiments, the display device 240 may automatically daub hits. In embodiments where the player must daub a hit in order to receive credit for the hit on one or more bingo cards 235, display device 240 may perform an accuracy check such that only characters that have been called may be daubed and/or only characters that have actually been called may count towards a winning pattern such as a coverall pattern or a line pattern.

As used herein the terms “symbol,” “icon,” and “character” all apply equally and interchangeably to one or more members of the set of game elements of the motif of an illustrative embodiments. As used in this description for clarity but not by way of limitation, the example symbols, icons, characters of the illustrations comprise numbers.

Playing Bingo

The systems, methods and apparatuses described herein enable a player in a public casino, such as a casino, BINGO hall, club, arcade, card room, charity hall, church or school additional options to win an electronic BINGO game played on a casino-style BINGO machine. On machines that embody illustrative embodiments players may control which or how many BINGO cards to play and/or the type of characters on their BINGO cards encouraging the player to play longer than they otherwise might. Giving players more control may increase the revenue the casino earns from a given machine and/or a given player by enticing a player to continue play for longer periods of time.

The objective of the traditional game of BINGO is to identify a winning pattern of spaces on a paper card. The card may have the letters “B” “I” “N” “G” “O” written over each column of numbers on the card. The card commonly has three or five rows of numbers, thus forming a table or matrix. The center space may be a “Free Space.” A caller or machine rolls a bin of BINGO balls, selects one, and calls out the letter and/or number combination on the selected ball. A player checks the column indicated by the called letter to see if any row under that letter contains the selected number. If so, the player daubs (covers) that number. If the player is the first who can daub a winning pattern (across, down or diagonally) the player calls “BINGO!” and the card is verified. If correct, the player wins the jackpot.

Casino-style electronic BINGO machines use a similar form of play to the traditional game of BINGO. Typically, casino-style BINGO machines show one or more electronic BINGO cards. The casino-style BINGO machine may simulate the rolling and/or selection of BINGO balls. Each BINGO ball may be selected from a pool of BINGO balls using a random number generator, a pseudo-random number generator or the ball selections may be predetermined such as from a list. When a symbol on a selected BINGO ball matches a symbol on a player's BINGO card (a “hit”), the player daubs the match. In some embodiments, the machine may daub matches for the player and/or assist the player in daubing a match when multiple cards are in play during a bingo game.

As used herein, the term “winning pattern” is illustrated using particular combinations of hits on the BINGO cards, but there is no limitation as to the patterns that can be offered to the player as winning combinations. Thus, the objective of a casino-style BINGO game is to daub hits on one of one or more BINGO cards to achieve a winning pattern (“BINGO!”) and the payout. In some embodiments, the maximum payout (maximum prize) and/or a jackpot may be awarded if each and every symbol on a player's BINGO card has been correctly daubed and/or is a free space. This may be referred to as a “coverall” pattern.

Clearly, the chance of achieving a winning payout, and in particular a maximum payout, increases with the number of hits achieved. While playing multiple BINGO cards simultaneously in a single game increases the chances of winning, it also increases the cost of each game. Thus, the player is engaged in a strategic challenge to win the most for the least bet.

Special Card Improvements to Casino-Style BINGO Game

To improve the game by adding interest, challenge and additional ways to win, illustrative embodiments provide special card options as improvements to the standard game overlay.

Playing the Game—Special Card Option

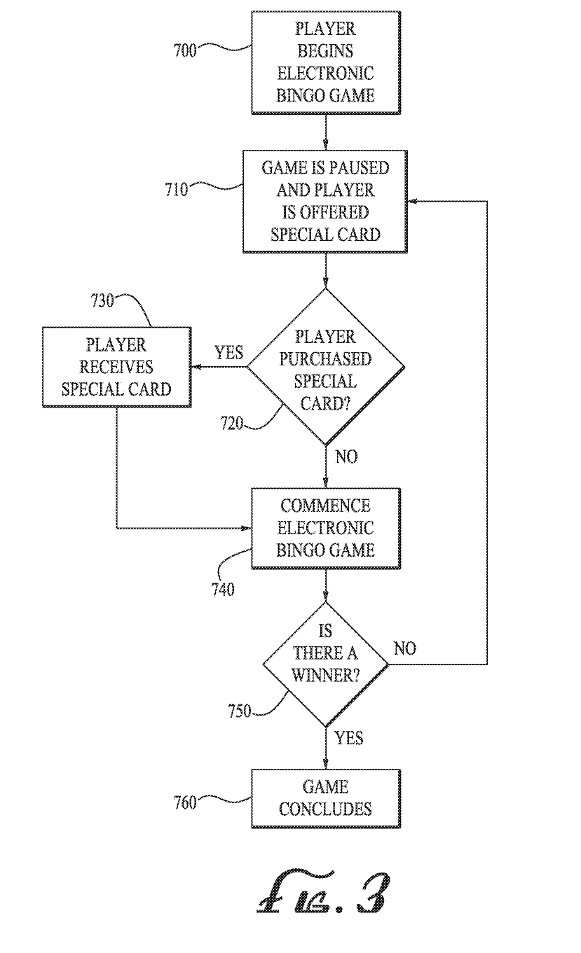

FIG. 3 illustrates a flow chart of a method of playing of the improved electronic casino-style BINGO game of one or more of the special card embodiments of illustrative embodiments that improve the existing game of casino-style BINGO. As above, for the sake of illustration, a BINGO game comprising BINGO cards each with fifteen symbols (characters) and ninety balls in the drawing pool will be described. This is known as “Spanish” style bingo. However, one skilled in the art will know that the same process is equally applicable to similar numbers of characters on BINGO cards and drawing pools, for example BINGO cards each with twenty-five symbols with or without a free space, and seventy-five balls in the drawing pool known as “American” style bingo.

At step 700, a player is playing an electronic BINGO machine in traditional fashion with one or more traditional BINGO cards for which the player may have been required to pay a fee. At step 710, after the BINGO game has commenced, the BINGO game is paused and the player is asked whether or not he or she would like to purchase a special card. The game may be paused at any predetermined point in the BINGO game, such as after about 33%, 46%, 62% and/or 75% of the bingo balls in the pool have been drawn, or after twenty, forty-one and/or fifty-six balls have been drawn from the drawing pool. For example, in a ninety ball embodiment, the game may be paused one or more times after forty-one balls have been drawn, fifty-four balls have been drawn, another number of balls have been drawn or a combination thereof. In ninety-ball embodiments with bingo cards 235 each containing fifteen symbols, in expected value, a player will have obtained nine hits on a fifteen symbol BINGO card once fifty-four balls have been drawn, and may be in need of six more hits to reach the maximum payout for a coverall pattern. However, a player may wish to increase his or her odds of winning by obtaining a bingo card with more hits than expected. Thus, at step 720, the player decides whether or not to purchase a new special card 400.

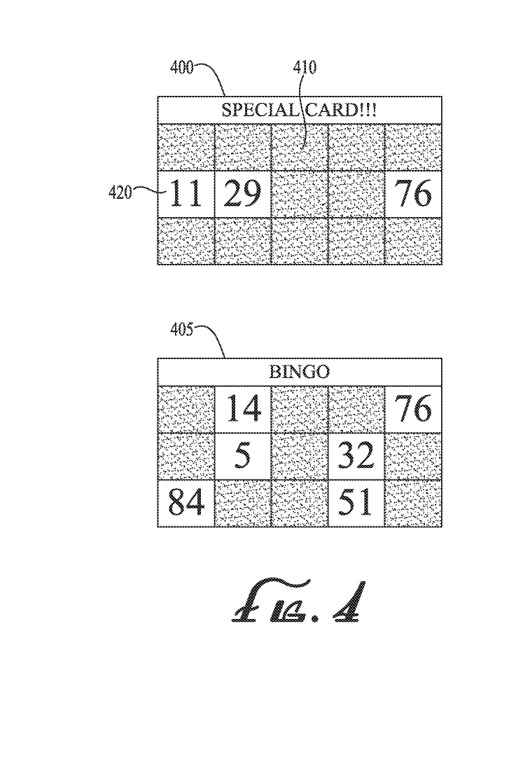

If the player purchases a special card 400 for a fee, the special card may replace one of the player's original BINGO cards, or the special card 400 may be provided to the player in addition to his or her cards previously in play. A player may purchase a special card 400 at step 730. When the player obtains a special card 400, the special card 400 may contain preexisting hits. In some embodiments, the special card 400 at the time of purchase may contain about 25%, 33%, 50% or 75% more hits, and/or between one and four more hits, than a BINGO card would have in expected value through normal play at the time the game is paused. For example, in a ninety ball embodiment where fifteen hits are needed to reach a coverall pattern and win the maximum prize, if the game is paused once fifty-four balls have been drawn, a traditional BINGO card will have on average (in expected value) nine hits through traditional play. A special card 400 in such a scenario may contain twelve hits (33% more hits than expected) at the time the special card is purchased and/or received by the player, as shown on special card 400 of FIG. 4. The number of hits that will be included on a special bingo card 400, if purchased, may be disclosed to the player prior to purchase, as illustrated in special card selection region 230 in FIG. 2.

In FIG. 4, two cards are shown at the time the game is paused and/or at the time a special card 400 is offered for purchase. One card is expected bingo card 405, representing an illustrative example of an expected bingo card after fifty-four balls have drawn in a ninety ball embodiment. The other card is special card 400, which represents one embodiment of a special bingo card that may be purchased mid-game, in this example after fifty-four balls have been drawn. As illustrated in FIG. 4, expected bingo card 405 includes nine hits when the game is paused and special card 400 includes twelve hits when purchased.

As shown in FIG. 4, special card 400 includes spaces for fifteen characters. In the example shown, twelve spaces are daubed spaces 410, for which the player is credited with obtaining a hit—even though the player did not have special card 400 at the start of the game. In the example shown, daubed spaces 410 are shown shaded (daubed). Also in the example shown, three spaces are undaubed spaces 420, which the player would still need to match from the drawing pool in order to obtain the maximum prize and/or the jackpot. In this example, the maximum prize is reached when all fifteen characters on special bingo card 400 are daubed (a coverall pattern). Undaubed spaces 420 may display characters that have not yet been drawn from the drawing pool, but which still may be drawn from the drawing pool as the BINGO game continues.

In some embodiments, special card 400 may be purchased in addition to the standard bingo cards already in play. Thus, once special card 400 is purchased, the player may continue play on his or her original cards, in addition to special card 400.

Thus, in the example of FIG. 4, a player purchasing special card 400 only needs three additional hits on special card 400 in order to reach a maximum prize, a winning pattern and/or win the jackpot, whilst he or she would have needed six additional hits in expected value on each bingo card 235 without special card 400. In this example, the special card 400 requires the player to obtain 50% fewer hits to reach the maximum prize than the player would need in expected value through traditional play, such as on representative expected card 405. In other embodiments, the special card may contain one, two, three or four additional hits than a traditional card would have through standard play at the same point in the game in expected value. The number of preexisting hits on the special card at the time of purchase may depend upon when during the game the special card option is offered, the price of the special card, the number of balls in the drawing pool and/or the number of symbols on the BINGO cards in the game, i.e., the number of rows and columns on the matrix on the BINGO cards. In some embodiments, special card 400 may require three additional hits towards a coverall pattern at the time special card 400 is received by a player.

Tables 1 and 2 illustrate some examples of when during a bingo game the game may be paused and a special card 400 may be offered, as well as a comparison of an exemplary special card 400 to an expected bingo card 405 at that juncture through traditional play.

TABLE 1
Exemplary Special Card Embodiments - Spanish Style BINGO
Assuming ninety balls and fifteen spaces on a bingo card, and where a
coverall pattern is the winning pattern.

| Number of Balls Drawn at | Expected Hits on | Hits on an Exemplary |
|---|---|---|
| Time Game is Paused | a Bingo Card | Special Bingo Card |
| 41 | 6.833 | 11 |
| 54 | 9.0 | 12 |
| 68 | 11.333 | 13 |

TABLE 2
Exemplary Special Card Embodiments - American Style BINGO
Assuming seventy-five balls and twenty-five spaces on a bingo card, with
one free space, and where a coverall pattern is the winning pattern:

| Number of Balls Drawn at | Expected Hits on | Hits on an Exemplary |
|---|---|---|
| Time Game is Paused | a Bingo Card | Special Bingo Card |
| 22 | 7.040 | 12 |
| 30 | 9.600 | 15 |
| 50 | 16 | 19 |

In certain embodiments, rather than the number of preexisting hits on special card 400 being based on expected values, the special card 400 may contain, at the time of receipt, more hits than the purchasing player actually has on any bingo card in the current game. In such an embodiment, if a player is currently playing six bingo cards, and the player's best card contains eight hits, then special card 400 may be guaranteed to contain more than eight hits, at least ten hits, or another number of hits that exceeds the number of hits on bingo cards 235 in the player's possession at the time of purchase of the special card.

In alternative embodiments, special card 400 may require three additional hits in order to reach a coverall pattern, regardless of when the game is paused or the number of spaces on BINGO card 235. As shown in FIG. 2, bingo cards 235 contain fifteen spaces, forty-one bingo balls have been drawn (bingo ball 250 showing the character “87” is the forty-first ball to be drawn), and special card selection region 230 indicates that if a special card 400 is purchased it will require three additional hits to obtain a coverall pattern.

At step 740 the BINGO game is commenced, and the remaining balls in the drawing pool are drawn. In some embodiments, the remaining balls in the drawing pool are drawn until there is a winner—for example until a coverall pattern is reached on a bingo card 235 or special bingo card 400. In other embodiments, a specified number of the remaining balls may be drawn, for example six, ten or twelve additional balls, and the system may check if there is a winner at step 750. If the additional balls have been drawn and there is no winner, the game may be paused for a second time, and the player may be offered yet another opportunity to purchase a special card 400. This procedure may continue until all the balls in the drawing pool have been drawn, a predetermined number of balls have been drawn, until there is a prize winner, jackpot winner and/or until a coverall pattern is reached by a player at step 760.

The cost of a special bingo card 400 may be the same price as the initial bingo cards 235 purchased by the player at the start of the BINGO game. In such embodiments, the player may only have the ability to purchase up to the same number of special bingo cards 400 as bingo cards 235 were purchased by that player at the start of the game. For example, if a player purchases five bingo cards 235 at the start of a BINGO game, then when the game is paused, the player may only purchase up to five special bingo cards 400. In other embodiments, the price of the special bingo card may be more than the cost of the bingo cards 235 purchased at the start of the game and the number of special bingo cards 400 purchased may not be limited by the number of bingo cards initially purchased at the start of the game. The time or times during a game when the system offers special card 400 to a player and/or the cost of a special card 400 may be customizable by a bingo game operator.

In illustrative embodiments, a bingo card such as special card 400 may be a winner and receive the jackpot if a coverall pattern is achieved. However, illustrative embodiments may also be implemented for other types of winning patterns such as a line or two lines. In certain embodiments, if multiple patterns are winning patterns, then a special card 400 may only be eligible to win a prize for the highest paying pattern available. For example, if a line, two lines and a coverall are all winning patterns, then the special card 400 may only be eligible to win a coverall pattern. In embodiments where multiple patterns are winning patterns, then the jackpot may be won for obtaining a coverall pattern only, and a lesser prize may be won for an alternative pattern such as a line. In the example shown in FIG. 2, the jackpot is $257.87 as illustrated at jackpot 300 and the lesser prize is a bicycle as illustrated at prize indicator 305.

As with a game of the prior art, the casino-style gaming system of illustrative embodiments may also offer the player the option to DOUBLE his bet. Thus, the addition of special card options may increase the player's winnings even more, greatly increasing the excitement and incentive to play the game of illustrative embodiments. Thus, an improved electronic casino-style BINGO gaming system has been described.

Computer System Architecture and Support

The methods and systems described herein are not limited as to the type of computer that may be used to implement the casino gaming unit of illustrative embodiments. Illustrative embodiments may be implemented and/or run on any computing device with the computational ability to perform and display the results of the games contemplated herein. Such a computing device may typically include a keyboard or means for user input or selections (such as a touch-screen keyboard or touch screen buttons), physical buttons, pointing input device (such as a mouse), a display device such as a monitor, or any appropriate combination of input and output devices. The contemplated computing device may also typically comprise a memory, a read only memory (such as a random access memory), a central processing unit and a storage device such as a hard disk drive (either local or remote and physically or logically coupled to the generalized computing device.) In some embodiments the computing device may also comprise a network connection that allows the computer to send and receive data through a computer network such as the Internet. Mobile computer platforms such as cellular telephones, smart phones, Personal Desktop Assistants (PDAs), kiosks, set top boxes, games boxes or any other computational devices, portable, personal or otherwise, may also qualify as a computing device capable of performing the methods described herein.

In various embodiments, illustrative embodiments may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier or media. In addition, the software in which various embodiments are implemented may be accessible through the transmission medium, for example, from a server over the network. The article of manufacture in which the programming is implemented also encompasses transmission media, such as a network transmission line and/or wireless transmission media. Thus, the article of manufacture also comprises the medium in which the code is embedded. Those skilled in the art will recognize that many modifications may be made to this configuration to implement such a system without departing from the scope of illustrative embodiments described herein.

Embodiments of the system described may comprise software that may execute on one or more computing devices having a computer usable memory medium (or a computer readable memory medium) and computer readable program code. The computer readable program code may include an input function, casino gaming functions and an output means such as a computer display, audio output, printing output and/or payment output.

Furthermore, embodiments of the present invention may be implemented as a program of computer-readable instructions and/or computer-readable data stored on a computer-readable medium. Programs, data and other information may constitute, but are not limited to, sets of computer instructions, code sequences, configuration information, and other information in any form, format or language usable by a general purpose computer or other processing device, such that when such a computer contains, is programmed with, or has access to the programs, data and other information the general purpose computer is transformed into a machine capable of performing the casino-style bingo games, such as those described above. A computer-readable medium suitable to provide computer readable instructions and/or computer readable data for the methods and processes described herein may be any type of magnetic, optical, or electrical storage medium including a disk, tape, CD, DVD, flash drive, thumb drive, storage card, or any other memory device or other storage medium known to those of skill in the art.

In one or more embodiments, the methods described here may not be limited as to the type of computing device it may run upon and may, for instance, operate on any generalized computer system that has the computational ability to execute the methods described herein and can display the results of the user's choices on one or more display devices. Display devices appropriate for providing user interaction with illustrative embodiments described herein includes, but is not limited to, computer monitors, cell phones, tablets, PDAs, televisions, or any other form of computer-controllable output display. As used herein, a computer system refers to but is not limited to any type of computing device, including its associated computer software, data, peripheral devices, communications equipment and any required or desired computers that may achieve direct or indirect communication with a primary computing device.

In one or more embodiments, a general-purpose computer may be utilized to implement one or more aspects of illustrative embodiments. In one or more embodiments, the computer may include various input and output means, including but not limited to a keyboard or other textual input devices, a display device such as a monitor or other display screen, and a pointing device and/or user selection indicator such as a mouse, keypad, touch screen, pointing device, or other known input/output devices known to those of skill in the art. The general-purpose computer described herein may include one or more banks of random access memory, read only memory, and one or more central processing unit(s). The general-purpose computer described herein may also include one or more data storage device(s) such as a hard disk drive, or other computer readable medium discussed above. An operating system that executes within the computer memory may provide an interface between the hardware and software. The operating system may be responsible for managing, coordinating and sharing of the limited resources within the computer. Software programs that run on the computer may be performed by an operating system to provide access to illustrative embodiments along with access to the computer resources needed to execute illustrative embodiments. In other embodiments, the casino-style gaming device may run stand-alone on the processor to perform the methods and games described elsewhere herein.

In one or more embodiments, the method(s) described herein, when loaded on or executed through or by one or more general purpose computer(s) described above, may transform the general-purpose computer(s) into a specially programmed computer able to perform the method or methods described herein. In one or more embodiments, the computer-readable storage medium(s) encoded with computer program instructions that, when accessed by a computer, may cause the computer to load the program instructions to a memory there accessible, thereby creates a specially programmed computer able to perform the methods described herein.

The specially programmed computer of illustrative embodiments may also comprise a connection that allows the computer to send and/or receive data through a computer network such as the Internet or other communication network. Mobile computer platforms such as cellular telephones, tablets, Personal Desktop Assistants (PDAs), other hand-held computing devices, digital recorders, wearable computing devices, kiosks, set top boxes, games boxes or any other computational device, portable, personal, real or virtual or otherwise, may also qualify as a computer system or part of a computer system capable of executing the methods described herein as a specially programmed computer.

Computer systems as described in this section are well known to those of ordinary skill in the art and are therefore not further described or illustrated herein.

One or more embodiments may be configured to enable the specially programmed computer of illustrative embodiments to take the input data given and transform it into a form usable by a system implementing electronic casino-style bingo games by applying one or more of the methods and/or processes of illustrative embodiments as described herein. Thus, the methods described herein are able to transform player selections using the system of illustrative embodiments to result in an output of the system such as a display of game results and/or a payout.

Further modifications and alternative embodiments of various aspects of illustrative embodiments may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims. In addition, it is to be understood that features described herein independently may, in certain embodiments, be combined.

What is claimed is:

1. A computer program product comprising a non-transitory machine-readable storage medium having computer program code stored thereon which when executed by a computer causes the computer to perform the computer program code, the computer program code conducting an improved electronic bingo game variation comprising:
generating a first electronic bingo card for an electronic bingo game, wherein the first electronic bingo card comprises a matrix of squares, each square comprising an assigned character chosen from a predetermined set of available characters;
drawing a series of bingo balls, each bingo ball comprising a character selected from the predetermined set of available characters, thereby creating a drawing pool, wherein a hit occurs when the character on a first drawn bingo ball matches one of the assigned characters on the first electronic bingo card;
pausing the electronic bingo game when a predetermined number of the bingo balls in the drawing pool have been drawn, wherein the predetermined number of the bingo balls is less than a number of bingo balls in the series of bingo balls;
offering a new electronic bingo card for purchase while the electronic bingo game is paused, the new electronic bingo card comprising a disclosed number of hits at a time of purchase, wherein the disclosed number of hits is greater than an expected number of hits on the first electronic bingo card at the time of purchase of the new electronic bingo card;
continuing the electronic bingo game with the new electronic bingo card and bingo balls drawn from a remaining portion of the drawing pool, wherein the new electronic bingo card comprises an undaubed character selected from the remaining portion of the drawing pool; and
awarding a jackpot prize when a particular electronic bingo card from a set of all first electronic bingo cards and new electronic bingo cards in the electronic bingo game obtains a coverall pattern.

2. The computer program product of claim 1, wherein at the time of purchase, the new electronic bingo card requires fifty percent fewer additional hits than the first electronic bingo card would be expected to require to reach the coverall pattern.

3. The computer program product of claim 1, wherein there are ninety available characters in the predetermined set and the electronic bingo game is paused when the predetermined number of the bingo balls is one of forty-one, fifty-four, sixty-eight or a combination thereof.

4. The computer program product of claim 1, wherein at the time of purchase the new electronic bingo card requires between one and four additional hits to reach a coverall pattern.

5. The computer program product of claim 1, wherein the matrix of squares comprises twenty-five squares and the drawing pool comprises seventy-five balls.

6. The computer program product of claim 1, wherein the matrix of squares comprises fifteen squares and the drawing pool comprises ninety balls.

7. The computer program product of claim 1, wherein the disclosed number of hits is greater than an actual number of hits on the first electronic bingo card.

8. An improved method of providing an electronic bingo-type game on a casino-style gaming machine, the method performed by a computer, wherein the computer further comprises a non-transitory storage device, the method comprising:
generating a first electronic bingo card for an electronic bingo game, wherein the first electronic bingo card comprises a matrix of squares, each square comprising an assigned character chosen from a predetermined set of available characters;
drawing a series of bingo balls, each bingo ball comprising a character selected from the predetermined set of available characters, thereby creating a drawing pool, wherein a hit occurs when the character on a first drawn bingo ball matches one of the assigned characters on the first electronic bingo card;
pausing the electronic bingo game when a predetermined number of the bingo balls in the drawing pool have been drawn, wherein the predetermined number of the bingo balls is less than a number of bingo balls in the series of bingo balls;
offering a new electronic bingo card for purchase while the electronic bingo game is paused, wherein the new electronic bingo card offered is three hits away from a coverall pattern;
continuing the electronic bingo game with the new electronic bingo card and bingo balls drawn from a remaining portion of the drawing pool, wherein the new electronic bingo card comprises an undaubed character selected from the remaining portion of the drawing pool; and
awarding a jackpot prize when a particular electronic bingo card from a set of all cards in play in the electronic bingo game obtains the coverall pattern.

9. The method of claim 8, wherein the new electronic bingo card is offered a first time when forty-one balls in the drawing pool have been drawn and a second time when fifty-four balls in the drawing pool have been drawn.

10. The method of claim 9, wherein the matrix of squares comprises fifteen squares and the drawing pool comprises ninety balls.

11. The method of claim 8, wherein the new electronic bingo card replaces the first electronic bingo card in the electronic bingo game.

12. The method of claim 8, wherein the set of all cards in play in the electronic bingo game comprises the first electronic bingo card and the special electronic bingo card.

13. An electronic apparatus comprising a non-transitory machine-readable storage medium having computer program code stored thereon which when executed by a machine causes the machine to perform a method of conducting an electronic bingo game variation, the method comprising:
generating a first electronic bingo card for an electronic bingo game, wherein the first electronic bingo card comprises a matrix of squares, each square comprising an assigned character chosen from a predetermined set of available characters;
drawing a series of bingo balls, each bingo ball comprising a character selected from the predetermined set of available characters, thereby creating a drawing pool, wherein a hit occurs when the character on a first drawn bingo ball matches one of the assigned characters on the first electronic bingo card;
pausing the electronic bingo game when a predetermined number of the bingo balls in the drawing pool have been drawn;
offering a new electronic bingo card for purchase while the electronic bingo game is paused, the new electronic bingo card comprising hits from the drawing pool when offered, and wherein the new electronic bingo card requires fewer additional hits towards a winning pattern than the first electronic bingo card in expected value at a time the game is paused;
continuing the electronic bingo game with the new electronic bingo card and bingo balls drawn from a remaining portion of the drawing pool, wherein the additional electronic bingo card comprises an undaubed character selected from the remaining portion of the drawing pool; and
awarding a jackpot prize when a particular electronic bingo card from a set of all first electronic bingo cards and new electronic bingo cards in the electronic bingo game obtains the winning pattern.

14. The electronic apparatus of claim 13, wherein the electronic bingo game is continued with both the new electronic bingo card and the first electronic bingo card.

15. The electronic apparatus of claim 13, wherein a cost of the first electronic bingo card is equal to a cost of the new electronic bingo card, and wherein a number of the new electronic bingo cards offered is equal to a number of the first electronic bingo cards generated.

16. The electronic apparatus of claim 13, wherein the winning pattern is a coverall pattern.

17. The electronic apparatus of claim 13, wherein the winning pattern is two lines.

18. The electronic apparatus of claim 13, wherein the wining pattern is a line.

19. The electronic apparatus of claim 13, further comprising guaranteeing that the new electronic bingo card requires fewer additional hits towards the winning pattern than the first electronic bingo card.

20. The electronic apparatus of claim 13, further comprising confirming an accuracy of hits daubed.
